(19) United States
(12) Patent Application Publication
(10) Pub. No.: US 2003/0127634 A1
(43) Pub. Date: Jul. 10, 2003

(54) CARPET STRETCHING APPARATUS

(76) Inventor: Glenda S. Schoeffler, Duson, LA (US)

Correspondence Address: John D. Jeter, 1403 Teche Drive, St. Martinville, LA, 70582, US

(21) Appl. No.: 10/042,934

(22) Filed: Jan. 8, 2002

(51) Int. Cl. B25B 25/00

(52) U.S. Cl. 254/201

(57) ABSTRACT

The housing of the kicker has a forward extension for attachment of a conventional carpet gripping head. Rotary motion of a driving motor is converted by a cam arrangement to reciprocate an internal mass to compress a spring in one direction and impact an anvil in the other. The impact drives the housing, and the gripped carpet, forward. Optional features include skids and extended control handles. Optionally, the anvil and extension can be directly connected and both resiliently attached to the housing to reduce shock delivered to the housing.

This invention pertains to apparatus for use in stretching carpet. More particularly, it pertains generally, but not limited to, powered apparatus to replace the knee kicked apparatus commonly used.

### BACKGROUND OF THE INVENTION

For many years the apparatus used for stretching carpet involved rather lengthy beam arrangements to push a carpet engaging end relative to a thrust resisting end, using a jack arrangement to lengthen the beam apparatus used, or a shorter apparatus was used having a carpet engaging end and a pad on the opposite end which was kicked by the knee of the operator. The lengthy apparatus is unwieldy and the kicked version causes occasional injury to the kicker.

Stretching of carpet, as defined herein, relates to application of the carper as floor covering, the stretching done to prevent wrinkling and other problems.

One individual usually operates the kicked version of the stretching apparatus now in use, and one person can operate the long beam arrangement but two-man operation is more common. The short version is rarely benefitted by a second person, in the actual stretching of carpet, because only one person can conveniently address the handling of the short version. Adding a power assist system to the one-man activity has been considered an added handling complexity. There is a need for apparatus that eliminates the knee kicking activity without adding handling complexity as a consequence of power apparatus usage.

The carpet engaging head of both forms of stretchers in common use has been found satisfactory. It usually has a multiple spike arrangement adjustably extending from the bottom of the head into the carpet being stretched. The heads have convenient attachment arrangements to engage the stretcher apparatus, whether beam or kicker extensions. The needed power assist apparatus can be fitted with the same carpet engaging head.

### SUMMARY OF THE INVENTION

The power assist embodiment involves a housing enclosed cam actuated hammer that impacts an anvil to impart axial shock to the housing. The impact is transmitted to the carpet engaging head attached to the enclosure. The cam is a rotary arrangement driven by a motor. The motor is selected and arranged for speed delivery that results in impact frequency most advantageous to the operation being performed. If a simple drive motor is used, it is attached directly to the housing.

The preferred cam arrangement compresses a spring while moving the hammer away from the anvil and turns the hammer loose periodically to respond to the spring and impact the anvil.

It has been found that an ordinary impact wrench driver has the right delivered shaft speed and will start the impact action without delivering reverse torque to the housing and the attached head. There are provisions to attach the power source to the housing.

Optional adaptations include skids for resting the apparatus on the carpet being stretched.

It is an object of this invention to provide an easily manageable powered arrangement to replace the knee kicked apparatus now used and injuring users.

It is a further object to provide powered apparatus that uses components already in satisfactory use.

These and other objects, advantages, and features of this invention will be apparent to those skilled in the art from a consideration of this specification, including the attached claims and appended drawings.

### BRIEF DESCRIPTION OF DRAWING

FIG. 1 is a side elevation of the preferred embodiment of the apparatus.

FIG. 2 is a top view of the apparatus of FIG. 1.

FIG. 3 is a sectional view of the housing portion of the apparatus with the hammer drawn back for release.

FIG. 4 is a sectional view of the apparatus of FIG. 3 with the hammer against the anvil.

FIG. 5 is a sectional view taken along line 5-5.

FIG. 6 is a sectional view taken along line 6-6.

FIG. 7 is an end view of the envelope of the housing fitted with optional skids and handle.

FIG. 8 is a side view of the apparatus of FIG. 7 with skids, handle and motor adapted to the housing.

FIG. 9 is a partially cut away side view of the back part of the housing with a motor attached by optional fittings.

FIG. 10 is a fragmented side view, mostly cut away, of a resilient end arrangement to permit an alternate energy delivery route to the carpet.

### DETAILED DESCRIPTION OF DRAWINGS

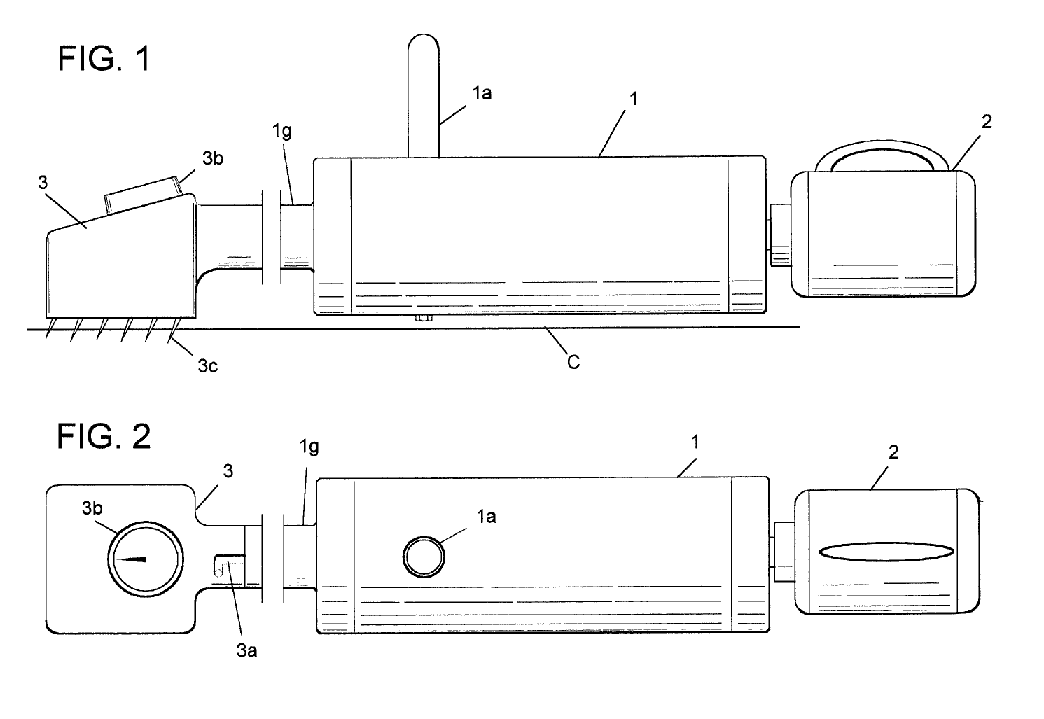

FIG. 1 shows main body 1 driven by motor means 2, attached to a carpet stretcher head 3. Handle 1a can be of any practical length to control the position of stretcher head 3 while the motor delivers power to the impact housing. Stretcher head 3 is a type now available. Knob 3b adjusts the extension of carpet gripper spikes 3c into the carpet C.

FIG. 2 is a top view of the apparatus of FIG. 1 and shows attachment “J” slot and pin arrangement 3a used for attaching such heads to carpet stretchers. Unit 2 is, preferably, an impact wrench. Such wrenches are available for purchase from many sources. They are commonly air or electric powered.

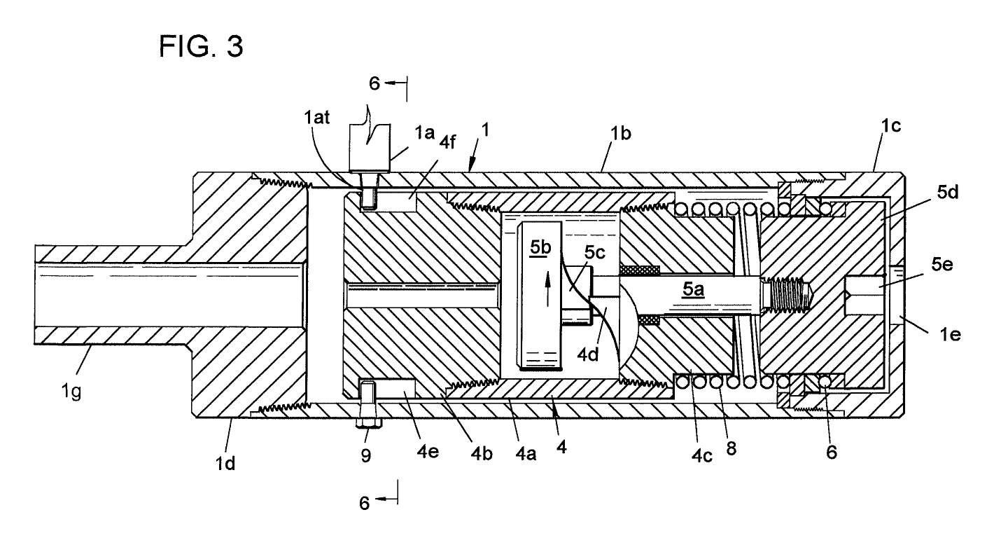

FIG. 3 is a side view, mostly cut away, showing the housing 1 and it's contents. The housing is primarily formed of tube 1b connecting ends 1c and 1d. In the opening of the housing mass 4b, connected by tube 4a to cam follower end 4c, are joined to form the mass of a hammer 4. Rotary input block 5d is rotated by a power source, preferably an impact wench that has a square drive output to engage the square opening 5e accessible through the housing opening le. Input block 5d rotates connected shaft 5a which drives cam carrier 5b rotationally on thrust bearing 6. Cam follower 4d is axially free for limited movement but rotationally fixed to the housing. Follower 4d engages the cam 5c on rotating carrier 5b to drive the hammer rightward to compress spring 8. The cam has a step function, or a saw tooth form, by which spring 8 is allowed to drive the hammer 4 against the anvil 1d which may makes up the left end of the housing.

Hammer 4 has axially extending slots 4f and 4e in mass 4b to accept pilot studs 1 at and 9, respectively, to prevent rotation of the mass. Extension 1g engages the conventional, and readily available, carpet gripping head.

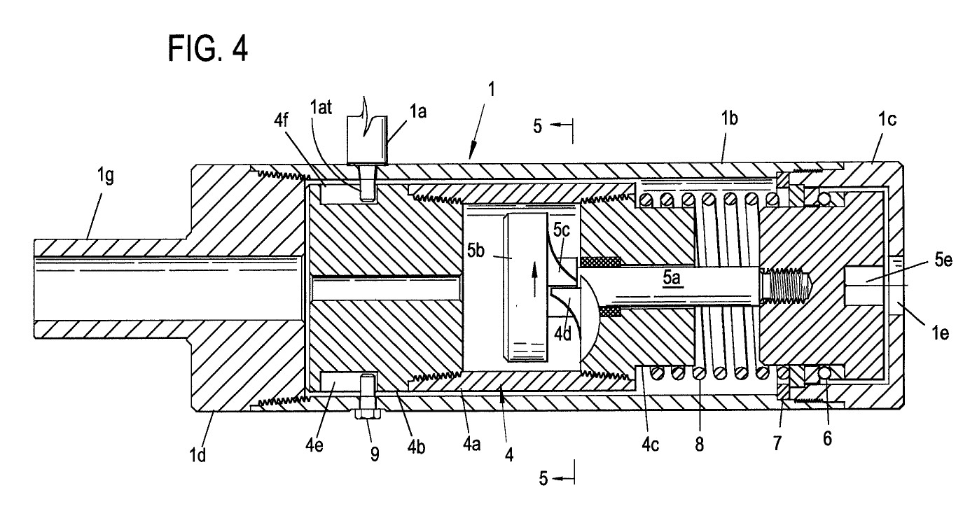

FIG. 4 is identical to FIG. 3 except for the phase of rotation of carrier 5b and the axial position of the hammer 4. The cams have fallen over the sudden drop portion of the cam and follower and spring 8 has driven the mass 4 into anvil 1d. The impact of the hammer on the anvil causes the housing to plunge a short distance leftward. The effect on carpet is much the same as would be caused if anvil 1d were jolted by a leftward impact of a knee applied to the prior art knee jolted apparatus.

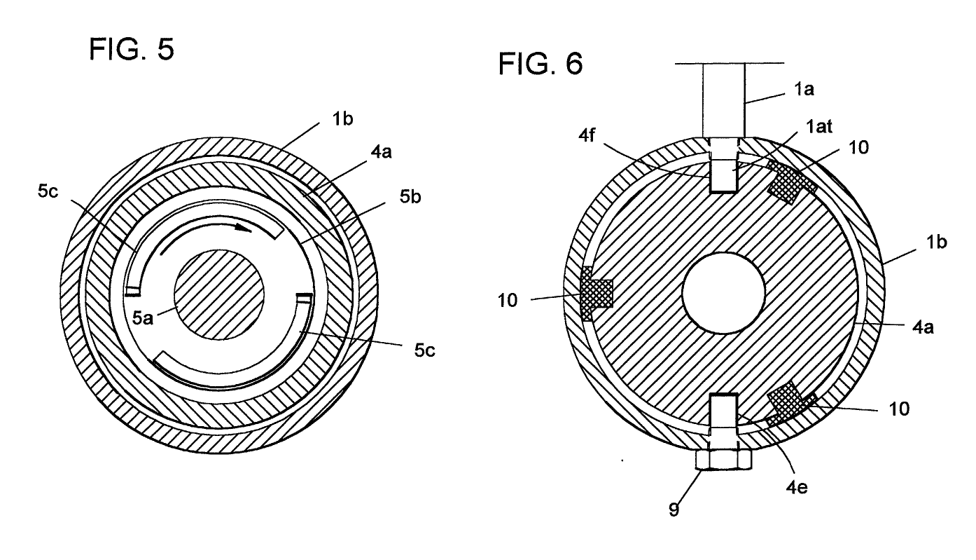

FIG. 5 is a section taken along line 5-5 of FIG. 4. The parts have been previously identified. Carrier 5b rotates and tube 4a, part of hammer 4, moves axially but does not rotate.

FIG. 6 is a section taken along line 6-6 on FIG. 3. Grooves 4e and 4f extend axially and fit reasonably close to studs 1 at and 9 in the peripheral direction. In conjunction with peripherally distributed bearing pads 10 the studs prevent impact induced deranged oscillation of the hammer 4. Pads 10, of metal or plastic bearing material, fit in holes in the outer wall of mass 4a and require no radial restraint. Once in the assembly, they cannot come out of the holes. Pads 10 may be distributed widely over the hammer outer surface.

Handle 1a can be supplied in many forms. Some users prefer a big knob on a short neck. Others prefer a long rod that can be guided from well above the carpet being stretched.

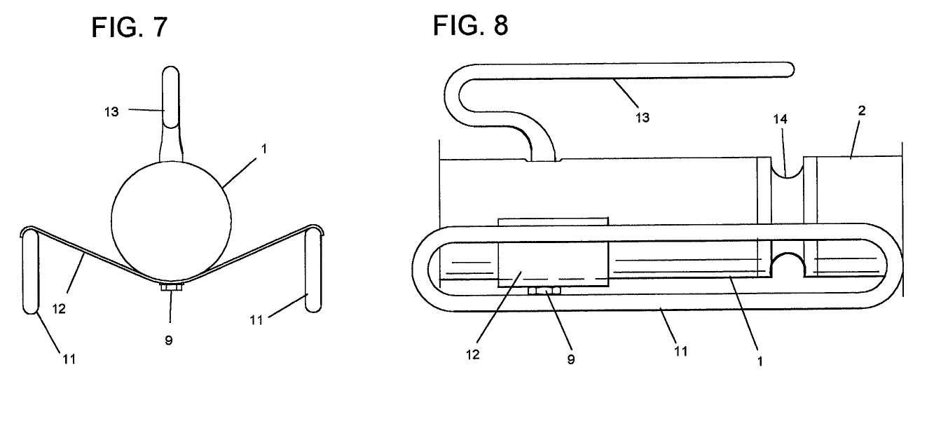

FIGS. 7 and 8 show a skid 11 on each side of the housing and a formed handle 13 on top. The springiness of spreader 12 allows some forward tilt control. The usual preference is for the operator, straddling the housing, to place shoe heels just outside the skids 11 and push the toes through the loop of the skids, grasp the handle 13 with both hands, adjust the weight distribution between shoe heels and toes to allow the skids to move forward under the toes but resist return, and hold the gains with the heels on the carpet. The handle 13 will be fitted with a trigger switch when adapter 14 secures the driving motor 2 to the housing 1.

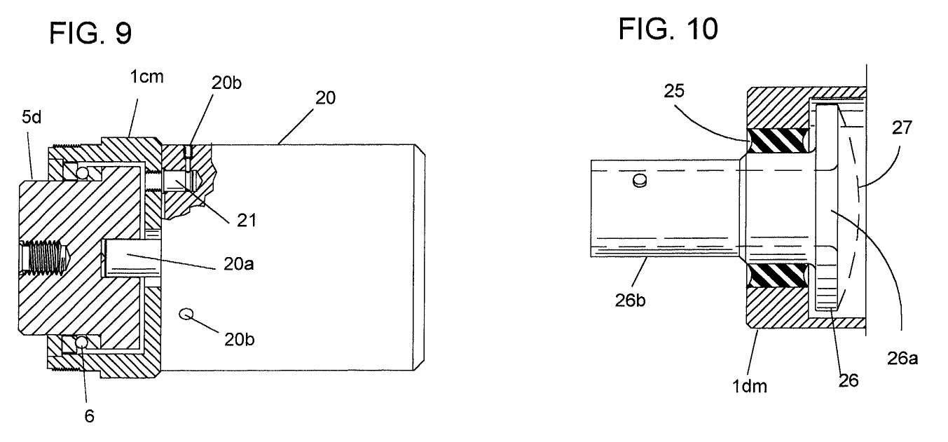

FIGS. 9 and 10 show construction alternatives. In FIG. 9, motor 20 is secured to the housing end cap 1c, now modified to 1 cm, by mounting studs 21 screwed into and projecting from the end cap. There are, preferably, three studs 21 distributed about the centerline of shaft 20a, about 120 degrees apart. Pointed set screws 20b cooperate with a groove on the studs to positively secure the motor. If the motor is to be used, the bore in component 5d, mating shaft 20a, is usually keyed.

FIG. 10 shows an alternative construction to reduce shock to the housing and increase productive effort applied to the carpet gripping head (not shown) attached to extension 26b. Anvil 26 is rubber mounted in the housing by molded rubber 25 filling the annulus between the neck of the anvil and the opening in endcap 1d, now modified to 1 dm. The rest of the apparatus is unchanged The hammer blow falls primarily upon the carpet gripping head to be attached to extension 26b.

Breathing hole 26a will be divided near dome 27 if the dome is needed to prevent cross axis vibration when the hammer hits an anvil not rigidly secured to the housing.

From the foregoing, it will be seen that this invention is one well adapted to attain all of the ends and objects hereinabove set forth, together with other advantages which are obvious and which are inherent to the tool.

It will be understood that certain features and sub-combinations are of utility and may be employed without reference to other features and sub-combinations. This is contemplated by and is within the scope of the claims.

As many possible embodiments may be made of the apparatus of this invention without departing from the scope thereof, it is to be understood that all matter herein set forth or shown in the accompanying drawings is to be interpreted as illustrative and not in a limiting sense.

The invention having been described, I claim:

1. A carpet stretching apparatus for the application of impact induced movement to carpet to move a portion of carpet relative to other portions of the carpet for the purpose of stretching the carpet along a floor, the apparatus comprising:
a) a housing with an internal opening, an axis, and a input shaft adapted to be driven in rotary motion by a rotating powered means, the housing having means at one end for attaching a carpet stretcher head;
b) the carpet stretcher head having means to secure itself to a carpet;
c) a surface, attached to said housing, definable as an anvil, arranged to be struck to transfer impact induced movement to said stretcher head;
d) a spring loaded mass to function as a hammer arranged to oscillate toward and away from the anvil, compressing the spring during movement away from the anvil; and
e) rotary motion to linear motion converter means arranged to convert rotation of the input shaft to reciprocating movement of the hammer to move the hammer to impact the anvil.

2. The apparatus of claim 1 wherein said mass is arranged to move in a direction of the axis of the housing.

3. The apparatus of claim 1 wherein said anvil is located between said hammer and said carpet stretcher head.

4. The apparatus of claim 1 wherein said rotary motion to linear motion converter comprises a cam on said input shaft and a cooperating cam follower on said hammer, the cam having a gradual rise and sudden drop feature arranged to gradually compress said spring and abruptly release said hammer to permit said spring to drive the hammer to impact the anvil before again moving the hammer to compress the spring.

5. The apparatus of claim 1 wherein said input shaft has an exposed connection accessible through an opening in the housing to attach a rotary drive means.

6. The apparatus of claim 1 wherein said housing has means for connecting a rotary drive means to said housing.

7. The apparatus of claim 1 wherein a rotary drive means is included, with means to engage said input shaft for rotation of the input shaft.

8. The apparatus of claim 7 wherein said rotary drive means is a powered nut driving rotary impact wrench.

9. The apparatus of claim 7 wherein said rotary drive means is an electric motor.

10. The apparatus of claim 7 wherein said rotary drive means is an air pressure powered motor.

11. The apparatus of claim 7 wherein said rotary drive means is adapted for mounting on the housing, for which mounting the housing is adapted.

12. A carpet stretching apparatus for the transfer of impact induced movement to carpet to move a portion of carpet relative to other portions of the carpet for the purpose of stretching the carpet along a floor, the apparatus comprising:
a) an elongated housing with an internal opening, an axis, and attachment means at one end for attaching a carpet stretcher head;
b) the carpet stretcher head having means to secure itself to a carpet;
c) a surface, connected to said housing, definable as an anvil, arranged to be struck to transfer impact induced movement to said stretcher head;
d) a mass to function as a hammer, in the opening, arranged for oscillating movement toward and away from the anvil;
e) converter means, in the opening, with an input shaft, arranged to convert rotation of the input shaft to the oscillating movement of the hammer to axially impact the anvil;
f) rotary drive means attached to the housing and arranged to provide rotating power to the converter means input shaft; and
g) bias means arranged to urge said hammer toward said anvil.

13. The apparatus of claim 12 wherein said converter means comprises a cam on said input shaft and a cooperating cam follower on said hammer, the cam having a gradual rise and sudden drop feature arranged to gradually move the hammer away from the anvil and abruptly release said hammer to permit said bias to drive the hammer to impact the anvil before again moving the hammer away from the anvil.

14. The apparatus of claim 12 wherein said rotary drive means is a nut driving powered impact wrench arranged to drive said input shaft.

15. The apparatus of claim 12 wherein said attachment means is directly connected to said anvil and both are attached to said housing by resilient means.

16. The apparatus of claim 12 wherein said bias is a variable volume chamber of compressible gas

17. The apparatus of claim 12 wherein said bias means is a spring.

18. The apparatus of claim 12 wherein said housing is supported by floor engaging skid means attached to the housing.

19. The apparatus of claim 12 wherein said rotary drive means is a powered motor attached to said housing.
